(19) United States
(12) Patent Application Publication
(10) Pub. No.: US 2010/0188681 A1
(43) Pub. Date: Jul. 29, 2010

(54) PRINT SYSTEM AND INFORMATION PROCESSING APPARATUS

(76) Inventor: Shinichi KAWANO, Osaka (JP)

Correspondence Address: BIRCH STEWART KOLASCH & BIRCH, PO BOX 747, FALLS CHURCH, VA, 22040-0747, US

(21) Appl. No.: 12/685,496

(22) Filed: Jan. 11, 2010

(30) Foreign Application Priority Data
Jan. 27, 2009 (JP) 2009-015365

(51) Int. Cl. G06F 3/12

(52) U.S. Cl. 358/1.13; 358/1.15

(57) ABSTRACT

A print system is provided that is capable of supporting various print parameters enabling the saving of printing materials such as sheets and toner and comprehending a saving status of the printing materials to prompt a user to save the printing materials. If a print parameter set by a user is a print parameter contributing to saving of printing materials such as sheets and toner, a PC transmits identification information identifying a user of the PC and an eco-point predetermined for the print parameter along with print data to an image forming apparatus. The image forming apparatus transfers the identification information and the eco-point received along with the print data to a server apparatus. The server apparatus receives and the identification information and the eco-point transmitted from the image forming apparatus counts/records in association with each other.

### CROSS-NOTING PARAGRAPH

This non-provisional application claims priority under 35 U.S.C. §119 (a) on Patent Application No. 2009-015365 filed in JAPAN on Jan. 27, 2009, the entire contents of which are hereby incorporated herein by reference.

### FIELD OF THE INVENTION

The present invention relates to a print system capable of prompting a user to save printing materials.

### BACKGROUND OF THE INVENTION

Conventionally, various techniques are proposed to prompt a user to save print sheets (hereinafter, sheets) consumed in an image forming apparatus. For example, Patent Document 1 discloses an image forming apparatus which is able to count/display the number of sheets savable by executing the printing based on the print parameter to comprehend a sheet saving status if a print parameter contributing to sheet saving is set such as N-Up (collective printing) and two-sided printing.

Although an image forming apparatus disclosed in Japanese Laid-Open Patent Publication No. 2003-186361 is able to comprehend the number of savable sheets, the image forming apparatus is unable to comprehend a saving status of printing materials including sheets, toner, etc. From a viewpoint of the saving of printing materials (resource saving), various print parameters enabling the saving of the printing materials such as sheets and toner exist other than N-Up and two-sided printing.

### SUMMARY OF THE INVENTION

It is therefore an object of the present invention to provide a print system capable of supporting various print parameters enabling the saving of printing materials such as paper and toner and comprehending a saving status of the printing materials to prompt a user to save the printing materials.

It is another object of the present invention to provide an information processing apparatus comprising a table that records point information predetermined for print parameters contributing to saving of printing materials consumed in an image forming apparatus among print parameters set at the time of printing of print data; and a point calculating portion that calculates the point information based on the table if a user sets a print parameter contributing to the saving of the printing materials, wherein the calculated point information is output when the print data is transmitted to the image forming apparatus.

It is another object of the present invention to provide a print system in which an image forming apparatus that prints print data and a plurality of the information processing apparatuses as defined in claim 1 that transmit print data to the image forming apparatus are connected through a network, wherein the information processing apparatus further comprises an identification portion that identifies a user of the information processing apparatus, and transmits the identification information that identifies the user of the information processing apparatus and the calculated point information along with the print data to the image forming apparatus, the image forming apparatus counts/records the identification information and the point information received along with the print data, in association with each other, and outputs the recorded point information to the information processing apparatus when receiving a point information output instruction signal from the information processing apparatus.

It is another object of the present invention to provide the print system, wherein a plurality of the image forming apparatuses and a server apparatus recording various pieces of information related to print data are further connected through the network, wherein the image forming apparatus transmits the identification information and the point information received along with the print data to the server apparatus, the server apparatus counts/records the received identification information and the received point information in association with each other and outputs the recorded point information to the information processing apparatus when receiving a point information output instruction signal from the information processing apparatus.

It is another object of the present invention to provide the information processing apparatus, wherein the point information recorded in the table is determined based on carbon-dioxide emission reduced by saving of the printing materials.

It is another object of the present invention to provide the information processing apparatus, comprising a storage portion that stores specific print data and point information calculated for the specific print data by the point calculating portion in association with each other.

### BRIEF DESCRIPTION OF THE DRAWINGS

FIG. 1 is a schematic of a print system according to the present invention;

FIG. 2 is a functional block diagram of a PC;

FIG. 3 is a functional block diagram of an image forming apparatus;

FIG. 4 is a functional block diagram of a server apparatus;

FIG. 5 is a diagram of an example of an eco-point table;

FIG. 6 is a diagram of an example of print job data;

FIGS. 7A to 7C are exemplary diagrams of record formats of eco-point;

FIG. 8 is an exemplary flow diagram of an eco-point generating/transmitting process;

FIG. 9 is an exemplary flow diagram of an eco-point recording process; and

FIG. 10 is a diagram of an example of a screen indicating a print parameter contributing to resource saving.

### PREFERRED EMBODIMENTS OF THE INVENTION

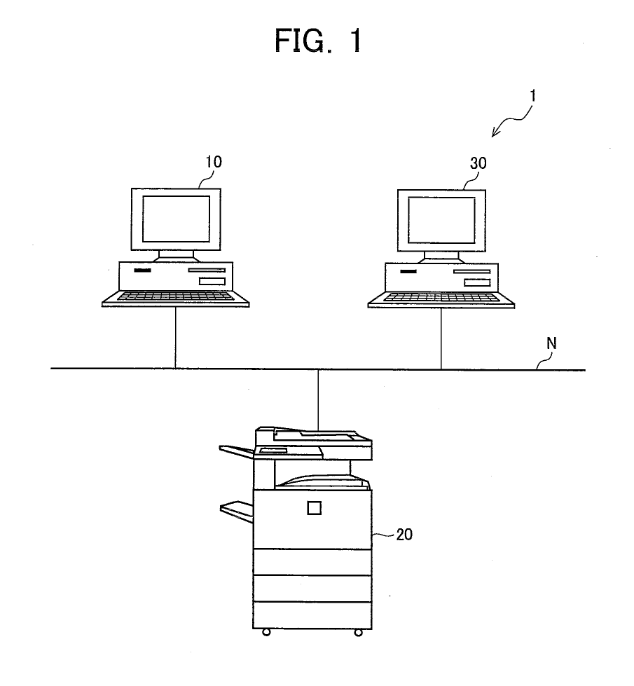

FIG. 1 is a schematic of a print system 1 according to the present invention.

The print system 1 is comprised of, for example, a PC 10 that is an information processing apparatus, an image forming apparatus 20, and a server apparatus 30 that records various pieces of information related to print data and these apparatuses are connected through a network N such as an intranet and the internet.

The PC 10 has applications such as word processing software, spreadsheet software, and a browser, and a print data generating application (printer driver) installed in. When a print parameter is set at the time of printing print data, if the print parameter is a print parameter contributing to saving of printing materials such as sheets and toner consumed in the image forming apparatus 20, the PC 10 transmits identification information identifying the user of the PC 10 and point information (hereinafter, eco-point) predetermined for the print parameter to the image forming apparatus 20 along with the print data.

The image forming apparatus 20 transfers the identification information and the eco-point received along with the print data to the server apparatus 30.

The server apparatus 30 receives the identification information and the eco-point transmitted from the image forming apparatus 20 and counts and records them in association with each other. When receiving a point information output instruction signal (request) from the PC 10, the server apparatus 30 outputs the recorded eco-point to a user's PC in a format displayable by a browser, for example, a markup language format such as HTML.

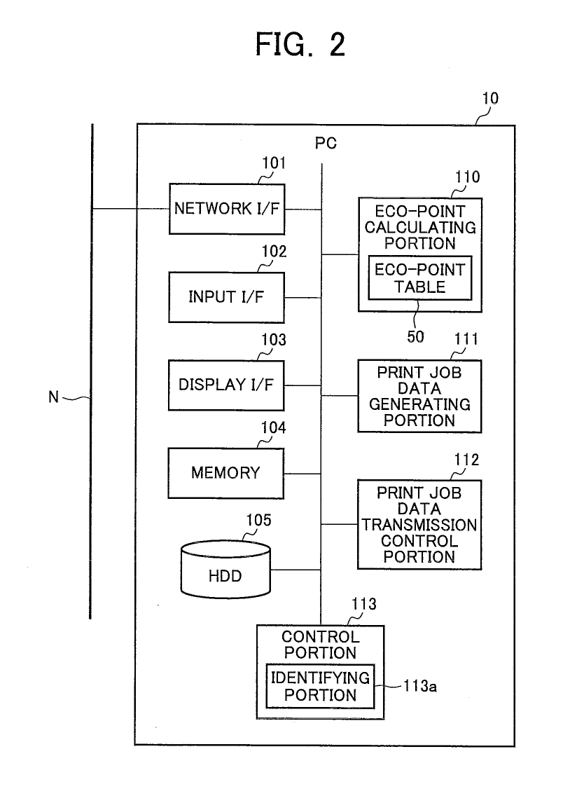

The PC 10 will be described with reference to a functional block diagram of the PC 10 depicted in FIG. 2.

Reference numeral 101 denotes a network I/F, which provides an interface function for the network N to perform data transmission/reception to/from another apparatus such as the image forming apparatus 20 connected to the network N.

Reference numeral 102 denotes an input I/F, which provides an interface function for input devices (not depicted) such as a keyboard and a mouse and reference numeral 103 denotes a display I/F, which provides an interface function for a displaying device (not depicted) such as a liquid crystal panel.

Reference numeral 104 denotes a memory comprised of ROM, RAM, etc., storing various pieces of information and reference numeral 105 denotes an HDD that records the applications such as word processing software, spreadsheet software, and a browser, and various data.

Reference numeral 110 denotes an eco-point calculating portion and, if a user sets a print parameter contributing to saving of printing materials and an instruction is given to execute the printing, the eco-point calculating portion calculates the eco-point based on an eco-point table 50 that records the eco-point (point information) predetermined for the print parameter contributing to the saving of the printing material. Details of the eco-point table 50 will be described later.

Reference numeral 111 denotes a print job data generating portion, which has a so-called printer driver function to generate and output print job data including print data and the eco-point calculated by the eco-point calculating portion 110, etc., to a print job data transmission control portion 112.

The print job data transmission control portion 112 controls the processing for transmitting the print job data output from the print job data generating portion 111 to the image forming apparatus 20.

Reference numeral 113 denotes a control portion comprised of CPU, etc., which controls the functional blocks. The control portion 113 includes an identifying portion 113a that identifies a user of PC 10. Various conventionally proposed techniques may be used for the user identification. For example, a user is identified by a login name input by the user at the time of login to the PC 10.

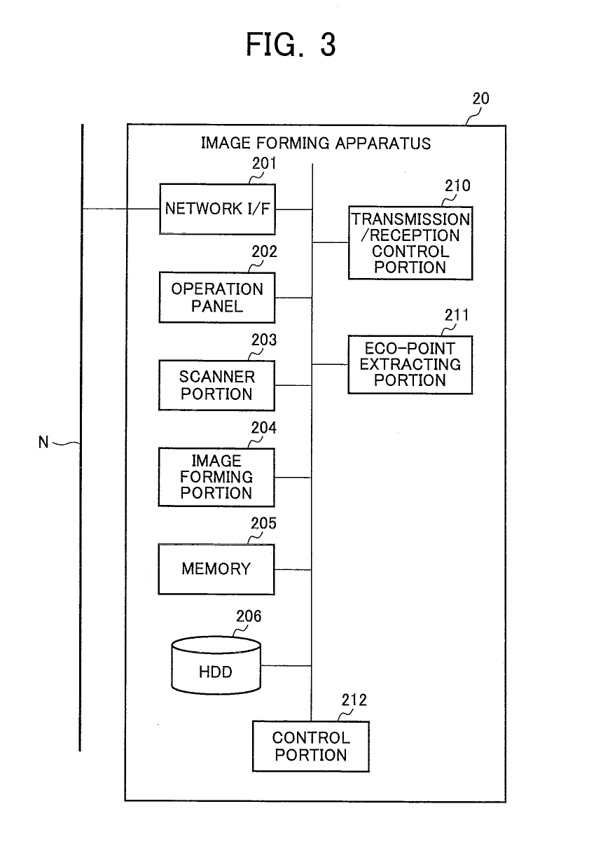

The image forming apparatus 20 will be described with reference to a functional block diagram of the image forming apparatus 20 depicted in FIG. 3.

Reference numeral 201 denotes a network I/F and reference numeral 202 denotes an operation panel for operating the image forming apparatus 20.

Reference numeral 203 denotes a scanner portion including an auto document feeder (ADF), etc., which scans a document to generate document image data.

Reference numeral 204 denotes an image forming portion that performs image forming based on the print parameter included in the print job data transmitted from the PC 10.

Reference numeral 205 denotes a memory that stores various pieces of control information and reference numeral 206 denotes an HDD that records the print job data transmitted from the PC 10 and the document image data generated by the scanner portion 203.

Reference numeral 210 denotes a transmission/reception control portion, which controls the processing for receiving the print job data transmitted from the PC 10 and outputting the print job data to an eco-point extracting portion 211 and the processing for transmitting the eco-point, etc., extracted by the eco-point extracting portion 211 to the server apparatus 30.

The eco-point extracting portion 211 receives the print job data output from the transmission/reception control portion 210, extracts the eco-point, etc., included in the print job data, and outputs the extracted eco-point, etc., to the transmission/reception control portion 210.

Reference numeral 212 denotes a control portion that controls the functional blocks.

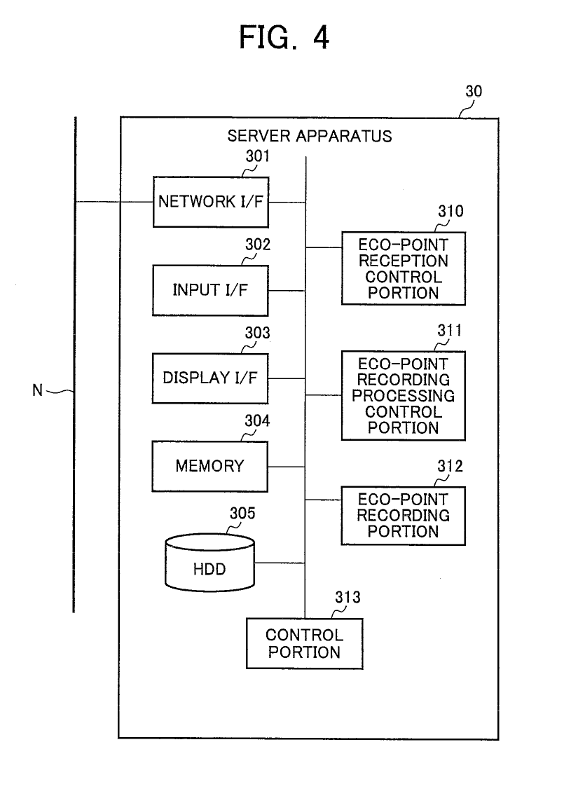

The server apparatus 30 will be described with reference to a functional block diagram of the server apparatus 30 depicted in FIG. 4.

Reference numeral 301 denotes a network I/F; reference numeral 302 depicts an input I/F; reference numeral 303 denotes a display I/F; reference numeral 304 denotes a memory that stores various pieces of control information; and reference numeral 305 denotes an HDD that records applications such as web server software, mail software, and a browser, and various data.

Reference numeral 310 denotes an eco-point reception control portion, which controls the processing for receiving the eco-point, etc., transmitted from the image forming apparatus 20 to output the received eco-point, etc., to an eco-point recording processing control portion 311.

The eco-point recording processing control portion 311 controls the processing for recording the received eco-point, etc., in an eco-point recording portion 312 comprised of an HDD, etc.

Reference numeral 313 denotes a control portion that controls the functional blocks.

Details of the generation/transmission processing of the print job data including the eco-point will hereinafter be described.

When a user A of the PC 10 clicks a print button displayed on a word processing software screen to print document data generated by using word processing software, etc., a print parameter setting screen (not depicted) is displayed on a monitor. The user A sets various print parameters through the print parameter setting screen and gives an instruction to execute printing.

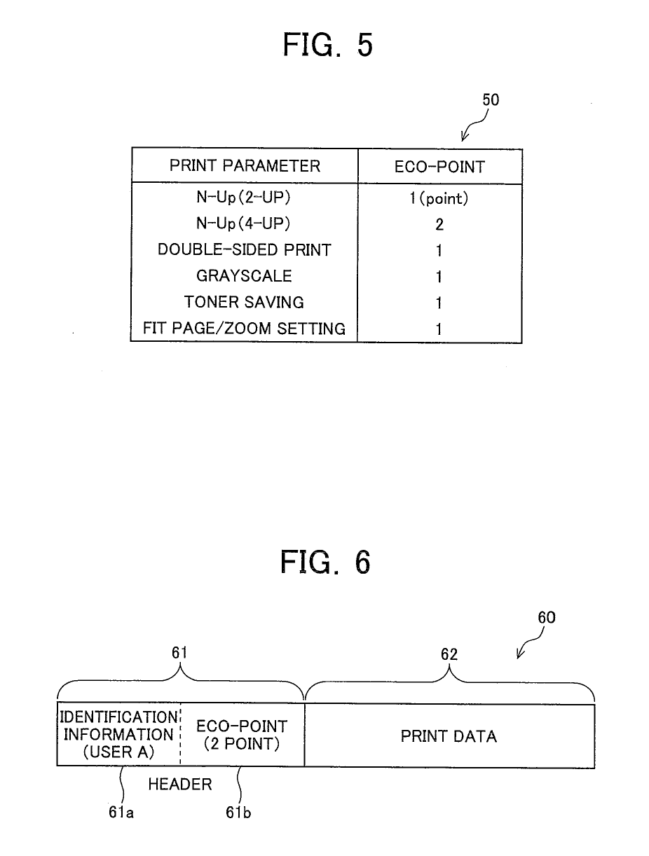

The eco-point calculating portion 110 analyzes the set print parameters to calculate an eco-point based on the eco-point table 50 depicted in FIG. 5.

The eco-point table 50 records print parameters contributing to resource saving of printing materials and eco-points predetermined for the print parameters.

For example, if the print parameter is 2-Up (two-sheet collective printing), the eco-point is one point and if the print parameter is grayscale, the eco-point is one point.

If the user A sets 2-Up and grayscale as the print parameters through the print parameter setting screen, the eco-point calculating portion 110 computes (calculates) the eco-point as two points.

The print job data generating portion 111 generates print data corresponding to the generated document data to generate print job data including the print data, identification information identifying the user A, such as a login name of the user A, and the calculated eco-point (two points).

FIG. 6 depicts an example of print job data and print job data 60 includes a header 61 indicative of various pieces of information (header information) related to the print job data, and print data 62. The print data includes the set print parameters.

The header 61 includes identification information 61a identifying the user of the PC 10 and an eco-point 61b related to the user. If the user set no print parameter recorded in the eco-point table 50, the print job data not including eco-point (without eco-point) is generated.

The print job data generating portion 111 outputs the generated print job data 60 to the print job data transmission control portion 112, and the transmission control portion 112 transmits the received print job data 60 to the image forming apparatus 20.

When the PC 10 transmits the print job data (print data) to the image forming apparatus 20, the eco-point calculated by the eco-point calculating portion 110 of the PC 10 may be output on the displaying device of the PC 10. In this case, the eco-point and the set print parameters are preferably converted and output in a format displayable by a browser, for example, a markup language format such as HTML.

The transmission/reception control portion 210 of the image forming apparatus 20 receives the print job data 60 and outputs the print job data 60 to the eco-point extracting portion 211.

The eco-point extracting portion 211 extracts the identification information 61a identifying the user of the PC 10 and the eco-point 61b from the received print job data 60 and outputs them to the transmission/reception control portion 210.

The transmission/reception control portion 210 transmits (transfers) the received identification information 61a and the eco-point 61b to the server apparatus 30. The printing of the print data 62 included in the print job data 60 is executed at the same time.

If the eco-point is not included (no eco-point is included), the above extraction processing is not executed.

The eco-point reception control portion 310 of the serve apparatus 30 that received identification information 61a and eco-point 61b outputs the identification information 61a and the eco-point 61b to the eco-point recording processing control portion 311.

The eco-point record processing control portion 311 counts/records the received identification information 61a and the eco-point 61b in association with each other in the eco-point recording portion 312 in association with each other.

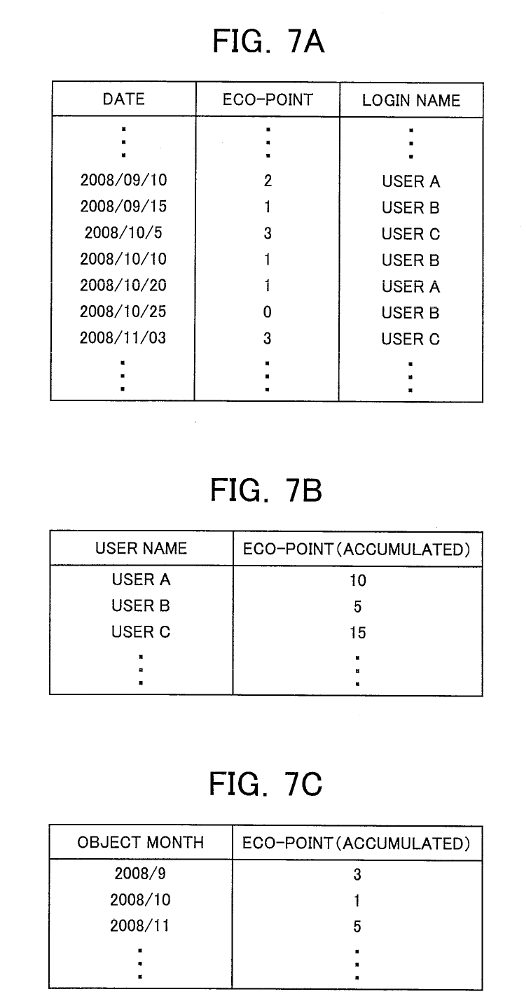

The eco-point record processing control portion 311 is able to record the received identification information 61a and the eco-point 61b in the eco-point recording portion 312 in various record formats. For example, as depicted in FIG. 7A, users (login names of the identification information), reception dates and times of eco-point (date), and eco-points may be recorded in association with each other. In other cases, users and total eco-points (accumulated) of the users may be recorded in association with each other as depicted in FIG. 7B or eco-point receiving months and total eco-points (accumulated) of the receiving months may be recorded in association with each other as depicted in FIG. 7C.

When receiving a point information output instruction signal (request) from the PC 10, the web server software recorded in the HDD 305 may convert and the eco-point (see FIGS. 7A to 7C) recorded in the eco-point recording portion 312 into, for example, a markup language format such as HTML and output the converted one to a user's PC. The mail software may also transmit the eco-point recorded in the eco-point recording portion 312 to a preliminarily registered e-mail address.

When receiving the point information output instruction signal from the PC 10, the server apparatus 30 outputs the point information recorded in the HDD 305 to the PC 10.

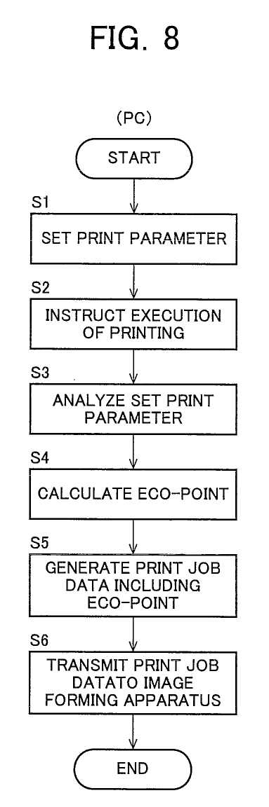

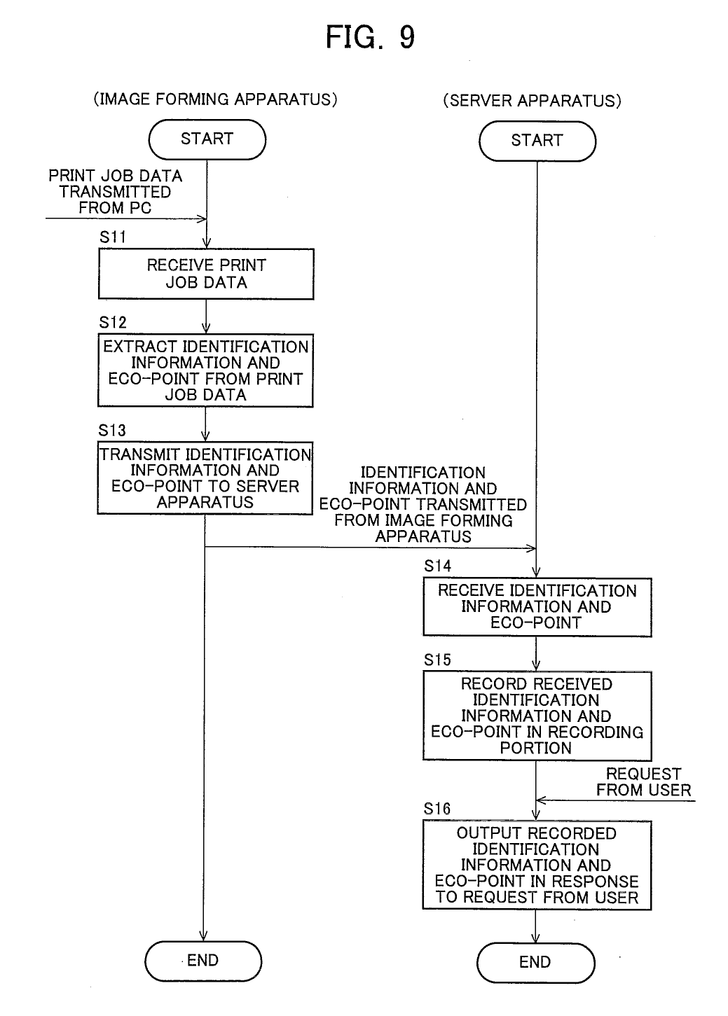

An eco-point generating/transmitting processing will be described with a flow diagram depicted in FIG. 8.

A user of the PC 10 sets print parameters contributing to saving of printing materials (step S1) and gives an instruction to execute printing (step S2) as described above. The eco-point calculating portion 110 then analyzes the set print parameters (step S3) to calculate the eco-point based on the eco-point table 50 depicted in FIG. 5 (step S4).

The print job data generating portion 111 generates print job data including the eco-point, etc., calculated at above step (step S5) and the print job data transmission control portion 112 transmits the print job data to the image forming apparatus 20 (step S6).

An eco-point recording processing will be described with reference to a flow diagram depicted in FIG. 9.

When the PC 10 transmits the print job data to the image forming apparatus 20 as described in the flow diagram of FIG. 8, the image forming apparatus 20 receives the print job data (step S11), extracts the identification information 61a and the eco-point 61b from the print job data (step S12), and transmits the identification information 61a and the eco-point 61b to the server apparatus 30 (step S13).

When the server apparatus 30 receives the identification information 61a and the eco-point 61b (step S14), the server apparatus 30 records the identification information 61a and the eco-point 61b in the eco-point recording portion 312 as depicted in FIG. 7 (step S15).

Subsequently, for example, the identification information 61a and the eco-point 61b recorded in the eco-point recording portion 312 are output to the user's PC in response to a request from the user (step S16).

Since this enables the user to comprehend a saving status of printing materials, the resource saving of the printing materials may be facilitated as a result.

### (First Variation)

The eco-point recorded in the eco-point table 50 may be determined based on carbon-dioxide emission reduced by the saving of the printing materials.

For example, it is assumed that if one sheet of documents is printed in a toner save mode, carbon-dioxide emission may be reduced by 0.03 kg as compared to printing in a normal mode. In this case, the eco-point recorded in the eco-point table 50 of FIG. 5 and corresponding to the toner save mode is set to three points.

Alternatively, it is assumed that if one sheet of documents is printed, 0.08 kg of carbon dioxide is emitted. If print job data corresponding to 100 sheets of documents is printed in 4-in-1 (four-sheet collective printing), carbon-dioxide emission reduced due to the saving of the printing materials (reduced carbon dioxide amount) is set to six points (0.08×100−0.08×25=6). The eco-point may be determined as above and the eco-point may be calculated in accordance with the number of printed sheets.

This enables the user to intuitively comprehend a level of contribution to the resource saving.

### (Second Variation)

In another case, the PC 10 may be provided with a storage portion that stores specific print data, for example, print data having a higher print frequency such as a template and point information calculated for the specific print data by the eco-point calculating portion 110 in association with each other.

In this way, if the point information of the print data is once calculated for the certain print data, the point information may not be calculated again and an amount of processing is alleviated.

### (Other)

The apparatus configuration of the above print system 1 may arbitrarily be modified and, for example, the print system may be comprised of one or a plurality of the PCs 10 and one or a plurality of the image forming apparatuses 20.

For example, if the print system is comprised of a plurality of the PCs 10 and the one image forming apparatus 20, the function of the server apparatus 30 is provided in the image forming apparatus 20. Specifically, the image forming apparatus 20 is provided with the eco-point recording processing control portion 311 and the eco-point recording portion 312 of the server apparatus 30 of FIG. 4, and the web server software and the mail software are recorded in the HDD 206 of the image forming apparatus 20. This enables the apparatus configuration of the print system to be simplified.

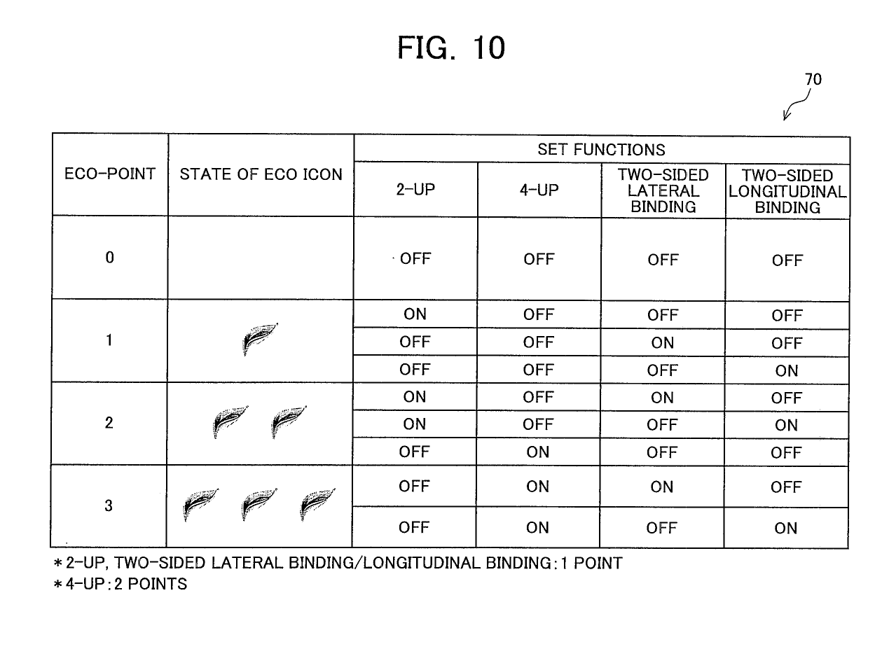

The types of print parameters contributing to resource saving, such as N-Up, and the eco-points determined for the print parameters may be displayed on the display device of the PC 10 along with eco-icons as depicted in a screen 70 of FIG. 10.

The reception dates and times (dates) depicted in FIGS. 7A to 7C may be the dates and times of reception of the print job data by the image forming apparatus 20 or the dates and times of reception of the eco-points by the server apparatus 30.

Before the image forming apparatus 20 transmits the eco-point to the server apparatus 30, the server apparatus 30 may be notified that the print job data includes the eco-point, and the eco-point, the identification information, and the reception date and time of the print job data may be transmitted if the server apparatus 30 makes a response to the notification.

The eco-point recording portion 312 of the server apparatus 30 may be the HDD 305.

According to the present invention, a saving status of printing materials may precisely be comprehended to prompt a user to save the printing materials and, as a result, the resource saving of the printing materials may be facilitated.

1. An information processing apparatus comprising:
a table that records point information predetermined for print parameters contributing to saving of printing materials consumed in an image forming apparatus among print parameters set at the time of printing of print data; and
a point calculating portion that calculates the point information based on the table if a user sets a print parameter contributing to the saving of the printing materials, wherein
the calculated point information is output when the print data is transmitted to the image forming apparatus.

2. A print system in which an image forming apparatus that prints print data and a plurality of the information processing apparatuses as defined in claim 1 that transmit print data to the image forming apparatus are connected through a network, wherein
the information processing apparatus further comprises an identification portion that identifies a user of the information processing apparatus, and transmits the identification information that identifies the user of the information processing apparatus and the calculated point information along with the print data to the image forming apparatus,
the image forming apparatus counts/records the identification information and the point information received along with the print data, in association with each other, and outputs the recorded point information to the information processing apparatus when receiving a point information output instruction signal from the information processing apparatus.

3. The print system as defined in claim 2, wherein
a plurality of the image forming apparatuses and a server apparatus recording various pieces of information related to print data are further connected through the network, wherein
the image forming apparatus transmits the identification information and the point information received along with the print data to the server apparatus,
the server apparatus counts/records the received identification information and the received point information in association with each other and outputs the recorded point information to the information processing apparatus when receiving a point information output instruction signal from the information processing apparatus.

4. The information processing apparatus as defined in claim 1, wherein the point information recorded in the table is determined based on carbon-dioxide emission reduced by saving of the printing materials.

5. The information processing apparatus as defined in claim 1, comprising a storage portion that stores specific print data and point information calculated for the specific print data by the point calculating portion in association with each other.

6. The information processing apparatus as defined in claim 4, comprising a storage portion that stores specific print data and point information calculated for the specific print data by the point calculating portion in association with each other.
